(19) United States
(12) Patent Application Publication
(10) Pub. No.: US 2006/0120928 A1
(43) Pub. Date: Jun. 8, 2006

(54) Chlorine dioxide generator

(76) Inventor: William Annacone, Stowe, VT (US)

Correspondence Address: PEARSON & PEARSON, LLP, 10 GEORGIA STREET, LOWELL, MA, 01852, US

(21) Appl. No.: 11/269,467

(22) Filed: Nov. 8, 2005

Related U.S. Application Data
(60) Provisional application No. 60/627,554, filed on Nov. 12, 2004.

(51) Int. Cl. F01N 3/20; B01J 19/00; B32B 27/04; B01J 10/02

(52) U.S. Cl. 422/129; 422/105

(57) ABSTRACT

A chlorine dioxide generator comprising a primary vessel and a canister which is attached to a receptacle at the bottom of the primary vessel and functions as a reaction vessel. A signal is generated to indicate when the canister is securely in place and a solenoid rod locks the canister in position until a chlorine dioxide reaction goes to completion. To start the reaction, water fills a priming chamber and solution chamber of the primary vessel, the priming chamber being located in an upper portion of the primary vessel, and an air pump forces a predetermined portion of water from the priming chamber via a feed line through a grommet at the top of the canister to a chemical reaction chamber of the canister along with a continuous air flow. The water from the feed line contacts precursor chemicals within the canister and chlorine dioxide gas is generated which passes through a gas flow chamber and into the primary vessel via a gas membrane valve.

### CROSS-REFERENCE TO RELATED APPLICATIONS

This is a nonprovisional patent application claiming priority of provisional application for patent Application No. 60/627,554, filed Nov. 12, 2004.

### BACKGROUND OF THE INVENTION

1. Field of the Invention

This invention relates generally to chlorine dioxide generators and in particular to chlorine dioxide generators having a primary vessel and replaceable, slide-in or screw-in reaction vessel.

2. Description of Related Art

Chlorine dioxide generators are primarily used in two fields, such as pulp and paper processing and drinking water purification. These generators are large, producing many pounds of chlorine dioxide gas daily. Since chlorine dioxide gas can become unstable in higher concentrations, which may accumulate in large-scale generation, these generators require skilled operators and numerous safely devices. In addition to the vast quantities of gas produced, the handling of precursor chemicals such as chlorine gas also becomes a safety concern. Though these large-scale generators could possibly be scaled down in size, they are still quite expensive and would require the same skills to operate.

There are also small-scale generators that use tea bag-like membrane technologies, which produce chlorine dioxide very slowly, on the order of many hours. These small-scale generators are currently being used or tested for various fields of use on a small scale. Additionally, the bags produce small amounts per bag, generally on the order of several grams or less of gas per bag.

The following prior art patents disclose gas generating apparatus and chlorine dioxide generators.

U.S. Pat. No. 5,004,586, issued Apr. 2, 1991 to Minoru Hayashi et al. and assigned to Nippon Koki Co., Ltd. discloses a gas generating apparatus for inflating an air bag protection against collision, life bag, rubber boat, escape chute, etc., comprising a housing and a combustion chamber. A threaded portion inside the housing is screwed into a cylinder which forms the combustion chamber with a multiplicity of combustion gas orifices around its outer circumferential wall. A gas generating agent is stored inside the combustion chamber nozzle is provided for ejecting high-pressure gas flowing from the combustion chamber into a mixing chamber. A gas generating agent in the form of either granules or pellets is stored in the combustion chamber. However, although this is a gas generating apparatus; it is not suitable for safely generating a carbide dioxide gas.

U.S. Pat. No. 6,071,483, issued Jun. 6, 2000 to Mauro Pastore discloses a reactor vessel and process for preparing a controlled-dosage chlorine dioxide solution comprising a hollow body having a first chamber and a second chamber which are mutually connected by a cylindrical duct which lies horizontally between the upper portion of chambers near removable plugs of the vessel. An aqueous solution or a buffered acid solution is introduced into a chamber. A water-soluble compound, capable of releasing chlorine dioxide and a water-soluble proton donor are introduced into a chamber. The vessel is tilted so as to introduce in one chamber a required amount of the aqueous solution, and then the vessel is returned to the uprighted position. A chemical reaction occurs inside the chamber which releases chlorine dioxide vapors which diffuse through a duct into the aqueous solution contained in another chamber. The vessel is turned upside down so as to fully mix the product in one chamber with the aqueous solution in another chamber. However, a closed loop system of a pressurized canister forcing a chlorine dioxide/air mixture into a primary solution vessel is not disclosed.

U.S. Pat. No. 6,238,643 issued May 29, 2001 to Appadurai Thangaraj et al. and assigned to Engelhard Corporation of Iselin, N.J. discloses a method of producing an aqueous solution of chlorine dioxide from the reaction of a metal chlorite and an acid forming component which do not react to produce chlorine dioxide in substantial absence of water. The reactants are separated from liquid water by a membrane which allows the controlled passage of liquid water and/or water vapor into contact with the reactants. However, this method of generating chlorine dioxide is very slow and a closed loop system of a pressurized canister forcing a chlorine dioxide/air mixture into a primary solution vessel is not disclosed.

Therefore, it is desirable to have a small-scale chlorine dioxide generator with safety features for generating a chlorine dioxide gas in a canister and forcing a chlorine dioxide/air mixture into a primary solution vessel in a reasonable amount of time.

### SUMMARY OF THE INVENTION

Accordingly, it is therefore an object of this invention to provide a self-priming chlorine dioxide generator comprising a primary vessel and a replaceable canister connected to the primary vessel.

It is another object of this invention to provide means for locking the canister within the bottom end of the primary vessel until a reaction goes to completion or an expert removes the canister.

It is a further object of this invention to provide a controller to monitor sensors which sense the canister is fully engaged, fluid level, sealing of the primary vessel and canister, and temperature.

It is another object of this invention to provide a closed loop system for generating chlorine dioxide solution using a combination vacuum and pressure pump attached to a vessel air space cap.

These and other objects are further accomplished by a chlorine dioxide generator comprising a primary vessel having a solution chamber, means for supplying priming water to a canister attached to the primary vessel, the canister having predetermined chemicals for producing chlorine dioxide gas, the canister sealably engages to the primary vessel, and means for providing a path for the priming water and air to pass through the primary vessel to the canister when the canister is engaged to the primary vessel. The generator comprises means for locking the canister within the primary vessel when the canister is fully engaged to the primary vessel. The primary vessel comprises a receptacle for directly engaging with the canister. The receptacle comprises a gas flow lid having a feed tube inserted in the lid, the lid being opened when the canister is fully engaged with the receptacle. The canister comprises a grommet in the engaging end of the canister for sealably engaging with the feed tube of the gas flow lid. The vessel receptacle comprises a membrane for allowing a gas generated in the canister to pass into the solution chamber of the primary vessel. The vessel comprises means for sensing when the canister is fully engaged to the primary vessel prior to start of a chemical reaction sequence. The canister comprises a relief valve to prevent an overpressure of the generated chlorine dioxide gas from occurring in the canister. The primary vessel comprises means for detecting a predetermined gas concentration in the solution chamber. The pump provides the air to the primary vessel. The controller is connected to the pump, the controller having a control panel for controlling and monitoring the operation of the chlorine dioxide generator. The canister comprises at least two chambers for storing the predetermined chemicals.

The objects are further accomplished by a chlorine dioxide generator comprising a primary vessel having a priming chamber and a solution chamber, the primary vessel comprises a first inlet for receiving air for delivery to the priming chamber and a second inlet for receiving water for delivery to the priming chamber and the solution chamber, a canister having predetermined chemicals for producing chlorine dioxide gas, the canister sealably engages to the primary vessel; and means for providing a path for the water and the air to pass from the priming chamber to the canister when the canister is engaged to the primary vessel. The generator comprises means for locking the canister within the primary vessel when the canister is fully engaged to the primary vessel. The chemicals react with the water provided to the canister from the priming chamber to produce the chlorine dioxide gas. The primary vessel comprises a receptacle for directly engaging with the canister. The receptacle comprises a gas flow lid having a feed tube inserted in the lid, the lid being opened when the canister is fully engaged with the receptacle. The canister comprises a grommet in the engaging end of the canister for sealably engaging with the feed tube of the gas flow lid. The vessel receptacle comprises a membrane for allowing a gas generated in the canister to pass into the solution chamber of the primary vessel. The primary vessel comprises means for sensing when the canister is fully engaged prior to start of a chemical reaction sequence. The canister comprises a relief valve to prevent an overpressure of the generated chlorine dioxide gas from occurring in the canister. The primary vessel comprises means for detecting a predetermined gas concentration in the solution chamber. The pump provides the air to the primary vessel. The controller is connected to the pump, the controller having a control panel for controlling and monitoring the operation of the chlorine dioxide generator.

The objects are further accomplished by a primary vessel for a chlorine dioxide generator comprising a solution chamber, a vessel plate attached to the top of the solution chamber, a priming chamber located within an upper portion of the solution chamber having an opening extending through the vessel plate, a vessel receptacle attached to a bottom of the solution chamber having a gas membrane located at the interface between the vessel receptacle and the solution chamber, the vessel receptacle comprises means for receiving a source of chlorine dioxide gas, and means for providing a path for liquid to flow from the priming chamber to a valve in the vessel receptacle. The vessel plate comprises a dome having a valve for receiving a first air supply tube, and a second air supply tube connects to the priming chamber for supplying air. The top vessel plate comprises an anti-siphon block having an input from the priming chamber and an output connected to the valve on the vessel receptacle. The gas membrane located at the interface between the vessel receptacle and the solution chamber allows for the passage of chlorine dioxide gas into the solution chamber. The primary vessel comprises a gas concentration detector positioned within the solution chamber. The vessel receptacle comprises a gas flow lid which opens when the chlorine dioxide gas source is attached to the vessel receptacle. The chlorine dioxide gas source comprises a canister having predetermined chemicals for producing chlorine dioxide gas.

The objects are further accomplished by a method of generating a chlorine dioxide solution comprising the steps of providing a primary vessel having a solution chamber and a canister attached to the solution chamber, providing water to the solution chamber, providing predetermined chemicals in the canister for producing chlorine dioxide gas for delivery to the primary vessel, and providing a path through the primary vessel for priming water and air to pass to the canister for generating the chlorine dioxide gas. The step of providing means for locking the canister within the primary vessel when the canister is fully engaged to the primary vessel. The path for the priming water and the air to pass to the canister comprises the step of the predetermined chemicals reacting with the priming water provided to the canister to produce the chlorine dioxide gas. The step of providing a receptacle having a gas flow lid with a feed tube inserted in the lid, the lid being opened when the canister is fully engaged with the receptacle. The step of providing a receptacle comprises the step of providing a membrane for allowing a gas generated in the canister to pass into the solution chamber of the primary vessel. The step of providing a primary vessel comprises the step of sensing when the canister is fully engaged prior to start of a chemical reaction sequence. The step of connecting a canister comprises the step of providing a relief valve to prevent an overpressure of the generated chlorine dioxide gas from occurring in the canister. The step of providing a primary vessel comprises the step of detecting a predetermined gas concentration in the solution chamber. The method comprises the step of providing a pump to supply the air to the primary vessel. The method comprises the step of providing a controller having a control panel for controlling and monitoring the operation of generating the chlorine dioxide solution.

The objects are further accomplished by a canister for generating chlorine dioxide gas comprising means for attaching the canister to a device for receiving the chlorine dioxide gas, means for storing chemicals within the canister to generate the chlorine dioxide gas, means for providing a path within the canister for air and water to come in contact with the chemicals to generate the chlorine dioxide gas. The attaching means comprises a threaded neck portion for screwing the canister into the device. The attaching means comprises a tube having a first end attached to the canister and a second end attached to the device for receiving the chlorine dioxide gas. The storing means comprises at least two chambers including a first chamber in a base portion of the canister for holding a first chemical and at least a second chamber in the base portion for holding a second chemical. The at least two chambers comprises holes between the first chamber and the at least second chamber, each of the holes being sealed by a water dissolvable film. The means for providing a path for air and water comprises a gas flow valve extending from a top portion of the canister to the chemical storing means. The gas flow valve comprises a grommet positioned on top of the valve for providing a seal when the canister is attached to the device for receiving the chlorine dioxide gas. The gas flow valve comprises a spring for sealing the valve when the canister is not connected to the device to prevent leakage of any chlorine dioxide gas. The canister comprises a relief valve to relieve an excess amount of pressure from within the canister. The canister comprises means for activating an engagement signal when the canister is completely attached to the device for receiving the chlorine dioxide gas.

The objects are further accomplished by a method of generating chlorine dioxide gas in a canister comprising the steps of attaching the canister to a device for receiving the chlorine dioxide gas, storing chemicals within the canister to generate the chlorine dioxide gas, providing a path within the canister for air and water to come in contact with the chemicals to generate the chlorine dioxide gas. The step of attaching the canister to a device for receiving the chlorine dioxide gas comprises the step of providing a threaded neck portion for screwing the canister into the device. The step of attaching the canister to a device comprises the step of providing a tube having a first end attached to the canister and a second end attached to the device for receiving the chlorine dioxide gas. The step of storing chemicals within the canister comprises the steps of providing a first chamber in a base portion of the canister for holding a first chemical, and providing a second chamber in the base portion for holding a second chemical. The steps of providing a first chamber and a second chamber in the base portion of the canister for storing chemicals comprises the steps of providing at least one hole between the first chamber and the second chamber, and covering the at least one hole with a water dissolvable film. The step of providing a path for air and water to contact the chemicals comprises the step of providing a gas flow valve extending from an upper portion of the canister to the stored chemical.

Additional objects, features and advantages of the invention will become apparent to those skilled in the art upon consideration of the following detailed description of the preferred embodiments exemplifying the best mode of carrying out the invention as presently perceived.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a perspective view of a chlorine dioxide generator showing a primary vessel and a canister according to a preferred embodiment of the present invention;

FIG. 2 is a perspective view of a top plate of the primary vessel of FIG. 1;

FIG. 3 is a cross-sectional view of an unengaged canister partially inserted within a vessel receptacle of a primary vessel;

FIG. 4 is a cross-sectional view of the chlorine dioxide generator of FIG. 1 connected to a pump and controller and having a fully engaged canister ready for generating a gas flow;

FIG. 5 is a cross-sectional view of a half-engaged canister with a partially opened gas flow lid;

FIG. 6 is a top perspective view of a canister according to the present invention;

FIG. 7 is an exploded view of the canister;

FIG. 8 is a side elevational view of a spring loaded gas flow valve of the canister;

FIG. 9 is a bottom perspective view of the two chemical chambers within the canister with a bottom cover removed;

FIG. 10 is a top plan view of a top gas valve plate of the vessel receptacle;

FIG. 11 is a top plan view of a bottom gas valve plate of the vessel receptacle; and

FIG. 12 is a flow chart of the safety checks performed by a controller for the chlorine dioxide generator.

### DESCRIPTION OF ILLUSTRATIVE EMBODIMENT

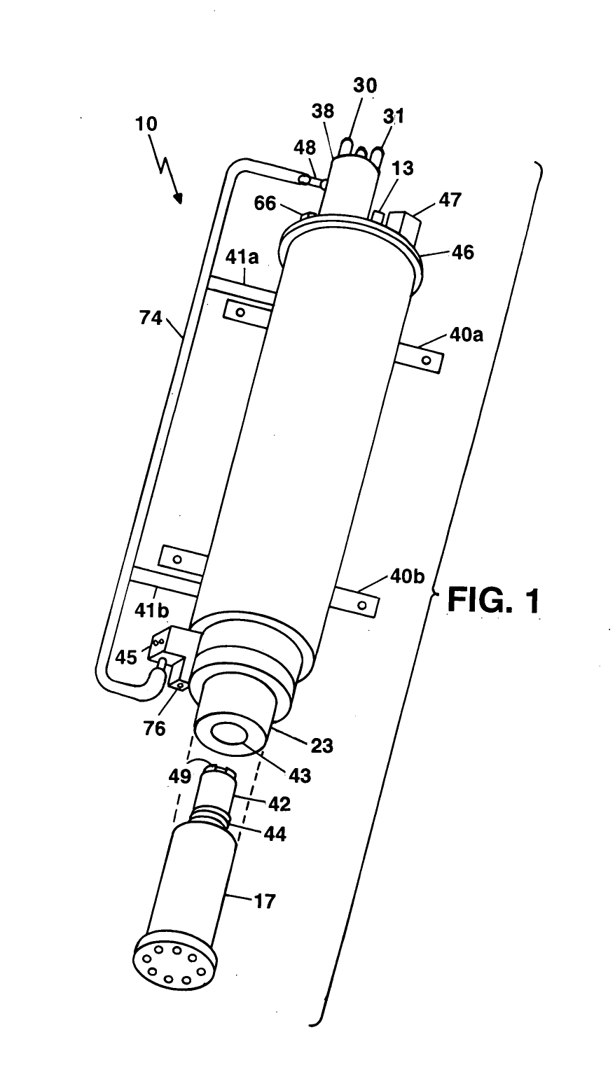

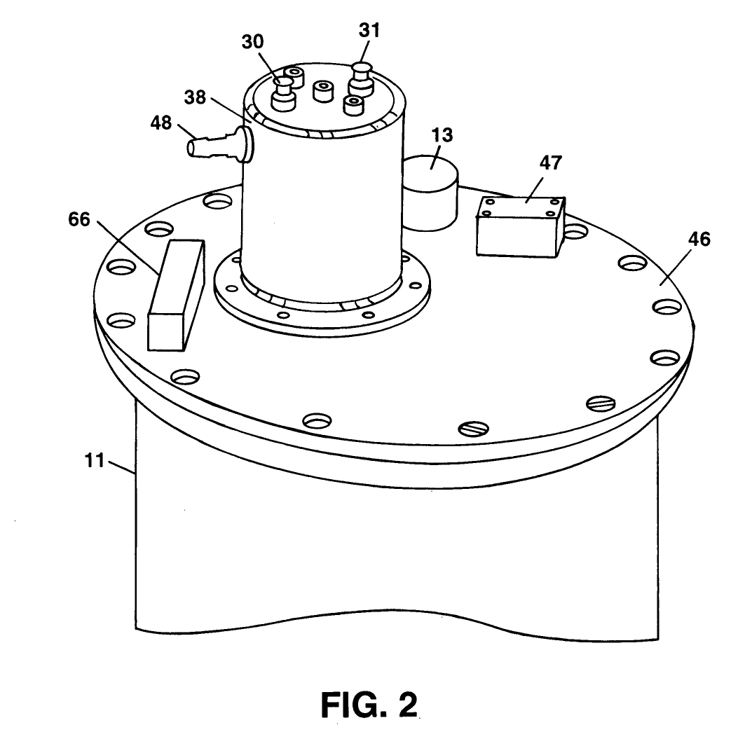

Referring to FIG. 1 and FIG. 2, FIG. 1 is a perspective view of a chlorine dioxide generator 10 according to the invention, and FIG. 2 is a perspective view of a top vessel plate 46 of the chlorine dioxide generator 10. The chlorine dioxide generator 10 comprises a primary vessel 11 and a canister 17 which attaches within a bottom end of the primary vessel 11. Extending from the top vessel plate 46 of the primary vessel 11 is a top vessel air space or dome 38, a double sealing cap 13, an anti-siphon block 47, and a chlorine dioxide gas concentration sensor feed-through 66 for fiber-optics only. Mounting plates 40a, 40b are provided to secure the primary vessel 11 to a support structure such as a wall or a post. A sight glass 74 is mounted on brackets 41a, 41b along the side of the primary vessel 11, and the sight glass 74 shows the amount of solution in the primary vessel 11. The top of the sight glass 74 connects to the top vessel air space dome 38. A lower end of the tube 74 connects to a drain block 45 mounted on a vessel receptacle 23 which is a lower portion of the primary vessel 11. The drain block 45 provides for draining the chlorine dioxide solution from the primary vessel 11.

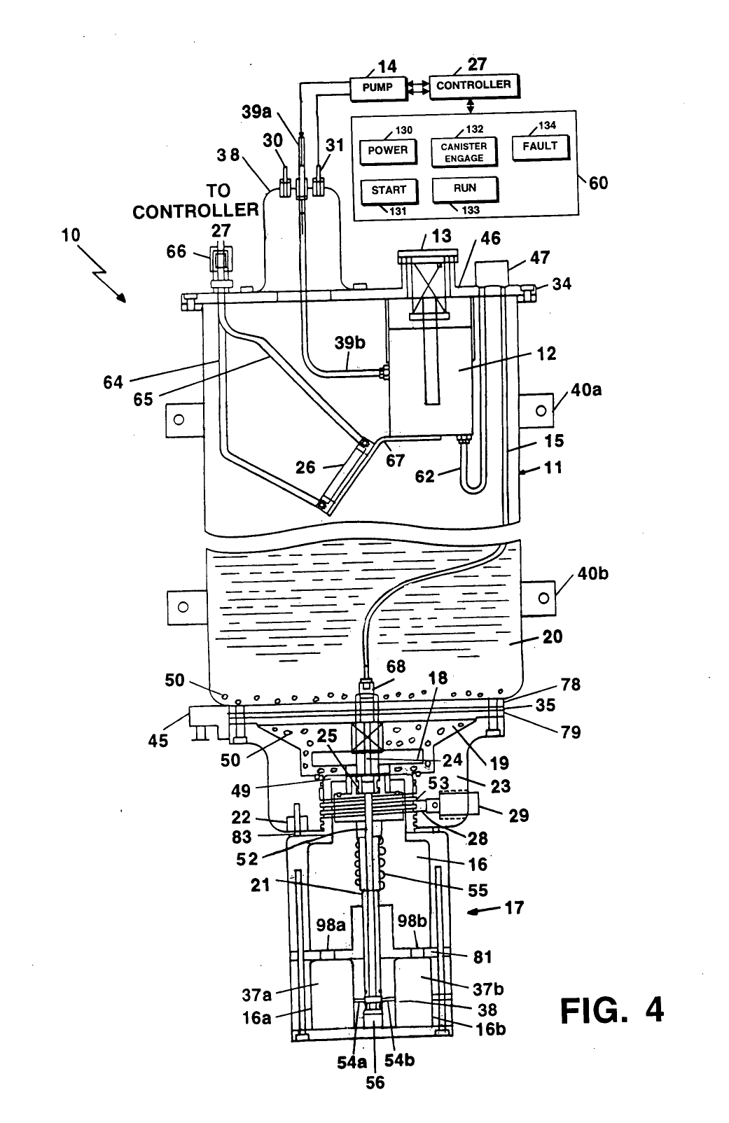

Referring to FIG. 1 and FIG. 4, FIG. 4 is a cross-sectional, elevational view of the chlorine dioxide generator 10 according to the invention having a fully engaged canister 17 for generating a flow of chlorine dioxide gas 50. The chlorine dioxide generator 10 interconnects to a pump 14 and controller 27. The inside of the primary vessel 11 comprises a priming chamber 12 and a solution chamber 20. A vessel receptacle 23 attaches to the bottom of the solution chamber 20, and the vessel receptacle 23 receives and secures the canister 17 within the primary vessel 11. The top vessel air space dome 38 receives an air supply tube 39a from the pump 14, includes a relief valve 30, and provides a valve connector 48. The double sealing cap 13 when removed provides an opening for adding water to the priming chamber 12 and the primary vessel 11.

A tube 39b extends from within the vessel air space dome 38 to a side of a priming chamber 12 to provide air to the priming chamber 12 from the pump 14. Another tube 62 connects to the bottom of the priming chamber 12 and extends through the top vessel plate 46 and into the anti-siphon block 47. Another tube 15 extends from the anti-siphon block 47 through the top vessel plate 46 down inside the primary vessel 11 and connects to a valve 68 in the center of a top gas valve plate 78 of the vessel receptacle 23. Extending from the bottom of the priming chamber 12 is an angled bracket 67 for mounting a chlorine dioxide gas concentration detector 26. Two fiber optic cables 64, 65 connect to opposite ends of the chlorine dioxide gas concentration detector 26 and the other ends of the fiber optic cables 64, 65 connect to a sensor 66 attached to and extending above top vessel plate 46.

As shown in FIG. 4, the canister 17 is fully engaged in the vessel receptacle 23 of the primary vessel 11, thereby raising a spring loaded gas flow lid 18 and activating a canister proximity microswitch 22 when the ridge 83 on top of the canister 17 pushes in the lever of the microswitch 22, resulting in a rod 28 of solenoid 29 to lock the canister 17 in place. The top vessel plate 46 is attached to an upper end of the primary vessel 11 and provides a surface for mounting the top vessel air space dome 38, the gas concentration sensor 66, the anti-siphon block 47 and the double sealing cap 13.

The primary vessel 11 comprises the top vessel dome 38 to which the relief valve 30 is connected, and the air input tube 39a extends from a pump 14 and interfaces with a connector on top of the vessel dome 38. The air tube 39a provides air to the top vessel dome 38 and air tube 39b continues the air flow to the priming chamber 12 located in an upper portion of the primary vessel 11 adjacent to the water inlet. An output tube 62 from the priming chamber 12 extends up to the top vessel plate 46 where it is connected to the anti-siphon block 47 and then to the air-primer feed line 15 extends from the anti-siphon block 47 through the primary vessel 11 and connects to connection valve 69 at the vessel receptacle 23. Also connected through the top vessel plate 46 are the ends of fiber optic cables 64, 65 extending from a gas concentration detector 26 through a feed-through 66 in the top vessel plate 46 and then to amplifiers (known by one of ordinary skill in the art) within the controller 27.

The air-primer feed line 15 extends downward to a connection valve 68 in the center of the vessel receptacle 23 wherein the feed line extension 52 continues through grommet 18 in the neck 42 and down into the canister 17. The feed line extension 52 connects with the canister chamber gas flow valve 36. The pump 14 may be embodied by Model No. BP-202 manufactured by Binaca Products of Temecula, Calif. The air pressure provided from the pump 14 to the canister 17 is typically 5-6 PSI.

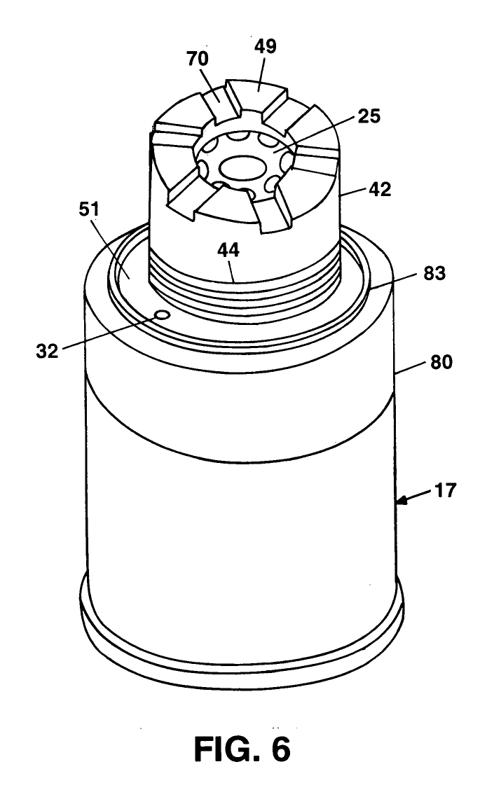

Referring to FIG. 1 and FIG. 6, FIG. 1 shows a bottom perspective view of the canister 17 and FIG. 6 is a top perspective view of the canister 17. The canister 17 comprises a neck 42 having a threaded lower portion 44. The neck 42 is inserted into an opening 43 of the vessel receptacle 23, and as the canister 17 is rotated, it screws into the vessel receptacle 23 of the primary vessel 11. The top surface 49 of the canister 17 comprises six radial slots 70. A center hole grommet 25 is positioned on top of a piston tube 52 and the grommet 25 is disposed adjacent to the inside surface of the top 49 of the canister 17. A small vent 32 is provided on an inner ledge. The vent 32 comprises a PTFE Goretex™ Teflon membrane material and an O-ring over the membrane, which holds the membrane.

The canister 17 may also be secured within the vessel receptacle 23 by a snap-in connection, and in another configuration, the canister 17 can be located separate from the primary vessel 11 having a tube connection between the top of the canister 17 and the vessel receptacle 23.

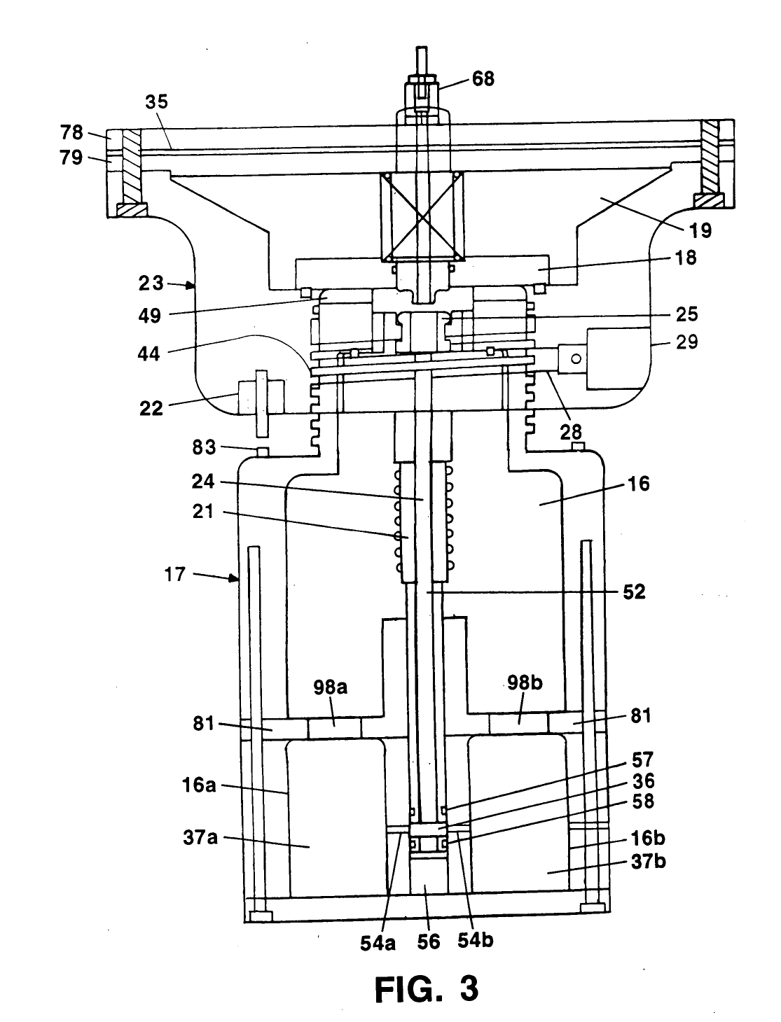

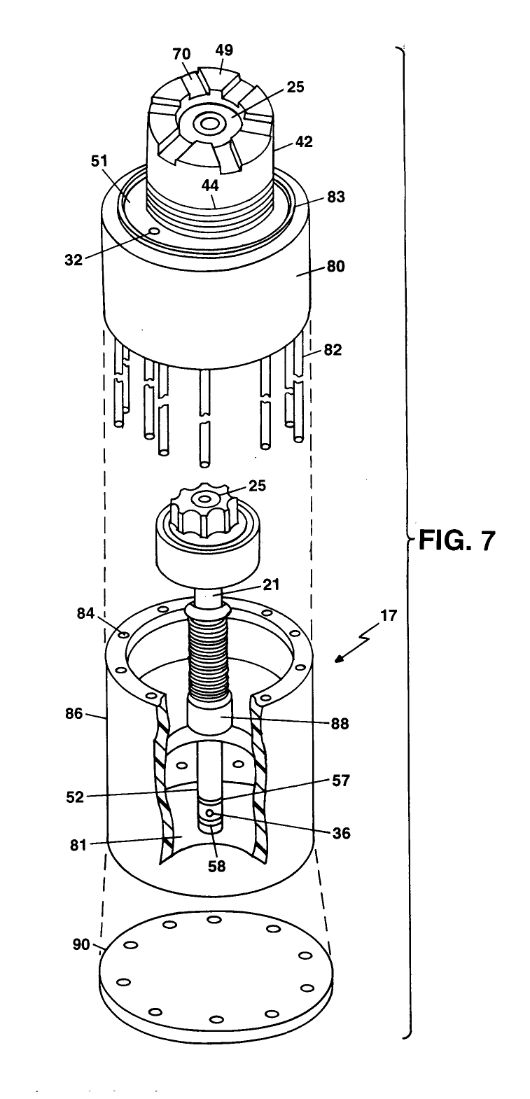

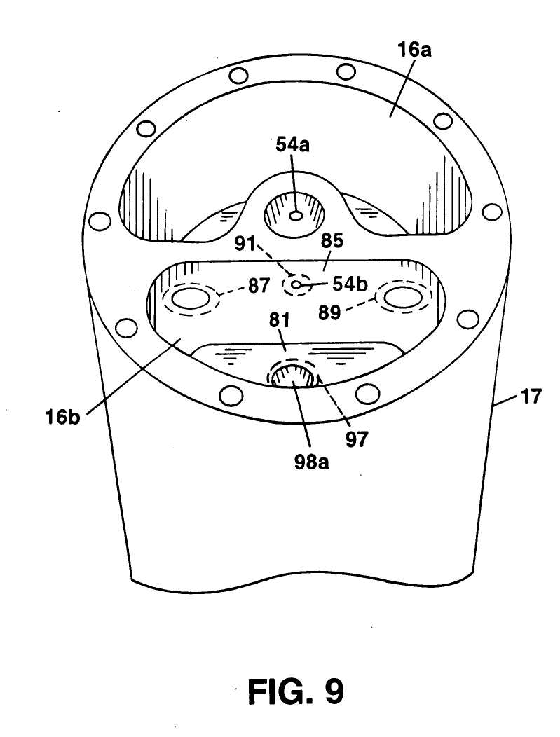

Referring now to FIG. 3, FIG. 6 and FIG. 7, FIG. 3 is a cross-sectional view of the canister 17 unengaged or partially inserted in the vessel receptacle 23 of the primary vessel 11. FIG. 6 is a top perspective view of the canister 17 according to the present invention, and FIG. 7 is an exploded view of the canister 17. When the canister 17 is partially inserted into the vessel receptacle 23 and unengaged as shown in FIG. 3, the top surface 49 contacts a spring loaded gas flow lid 18 within a gas flow chamber 19 of an upper portion of the vessel receptacle 23. When the canister 17 is further rotated to become fully engaged with the vessel receptacle 23, a push-pull solenoid 29 is turned-off causing a solenoid rod 28 to engage into a blind hole 53 in the threaded area of the canister 17 to lock the canister 17 within the vessel receptacle 23. The canister 17 is self-sealing by means of the grommet 25 in the top center of the spring loaded gas flow valve 21 which mates with an air initiator/feed tube 24 positioned through the center of the gas flow lid 18. The top surface of the canister neck 49 pushes up the gas flow lid 18 thereby providing a path for gas 50 produced in the canister 17 to flow into the gas flow chamber 19 of the vessel receptacle 23. When the grommet 25 is engaged with the air initiator/feed tube 24, it seals from atmosphere insuring air and water cycling to occur through the chlorine dioxide generator 10 without leaks. The upper portion of the vessel receptacle 23 comprises a gas membrane 35 secured between a top gas valve plate 78 and a bottom gas valve plate 79 for the generated chlorine dioxide gas air mixture 50 to pass through into primary vessel 11. A canister proximity microswitch 22 is located in the bottom wall of the vessel receptacle 23, and activates when the canister 17 is fully engaged for signaling a controller 27 (FIG. 4) to start a reaction sequence to generate the chlorine dioxide gas 50. Chemicals 37a, 37b for producing the chlorine dioxide gas 50 are disposed in separated storage chambers 16a, 16b of the canister 17. The chemicals 37a, 37b comprise sodium chlorite 37a in a first storage chamber 16a and citrus acid 37b in a second storage chamber 16b. An alternate embodiment for chemical storage includes providing the chemicals within pouches stored in the separate chambers 16a, 16b in the canister 17. Dissolvable port seals attached over holes or ports 87, 89 (FIG. 9) between chambers 16a, 16b provide for safety during shipment.

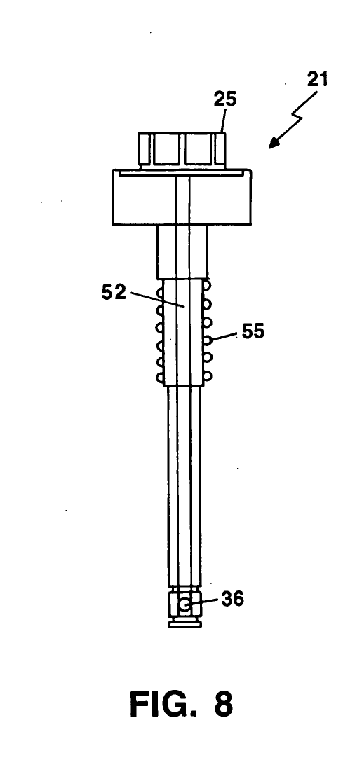

Referring to FIG. 3 and FIG. 8, FIG. 8 shows a side elevational view of the spring loaded gas flow valve 21. A gas valve tube 52 extends from the grommet 25 down to a gas flow valve 36 in the canister reaction chamber 16, and ports 54a, 54b open to each of the chemical storage chambers 16a, 16b. Below the ports 54a, 54b of the canister 17 is a plug 56 (FIG. 3) which seals the two chemical chambers 16a, 16b when the gas valve 52 is in the up position such as when the canister 17 is disengaged. O-rings 57, 58 are provided above and below the gas flow valve 36 to prevent any flow of water or air into chambers 16a and 16b when the gas flow valve is in the “up” position. When it is engaged or in the “down” position, water and air flow are enabled. O-ring 58 seals from atmosphere when the stem of the gas valve 52 is “up”, and O-ring 57 prevents air flow up the stem of gas valve 52 when the stem of the gas valve 52 is “down” and air is flowing. A spring 55 is provided just above the center of the gas valve tube 52 which provides the spring loading when the canister 17 is engaged with the vessel receptacle 23.

Referring to FIG. 9, a bottom perspective view of the two chemical chambers 16a, 16b within the lower portion of the canister 17 is shown. The bottom cover 90 is removed from the canister 17. Two holes or ports 87, 89 are provided in the wall between the chemical chambers 16a, 16b which provide for mixture of water and chemicals to produce chlorine dioxide gas 50. A disc made of Polyvinyl Alcohol (PVA) film is attached over each hole or port 87, 89 and the discs are water soluble. The discs 87, 89, 91 prevent the chemicals from commingling during storage and allow them to mix when water is added to either or both chemical chambers 16a, 16b. The outer perimeter of one side of each disc comprises an adhesive for securing the disc around each hole or port 87, 89. A PVA disc 91 covers port 54b. PVA discs 95 cover each of ports 98a and 98b to maintain the dry chemicals in their respective chambers 16a, 16b during storage and dissolved when water is added to allow the generated chlorine dioxide gas 50 and air mixture to flow to the solution chamber 20.

Referring again to FIG. 4, a control panel 60 is connected to a controller 27 which controls the pump 14 for supplying air to the generator 10. The control panel 60 comprises a power switch 130, a START button 131, a FAULT indicator 134 and a canister engage push button switch 132. The START button 131 turns on the pump 14 for a predetermined amount of time after certain safety checks are performed. The FAULT indicator turns-ON if the concentration of the chlorine dioxide gas does not reach a certain level in a predetermined amount of time. The push button switch 132 enables the canister 17 to become engaged with the primary vessel 11. The controller 27 comprises a programmed logic controller (PLC), and a power supply (24 VDC). The PLC may be embodied by a PLC model manufactured by Keyence Corporation of America of Woodcliff, N.J.

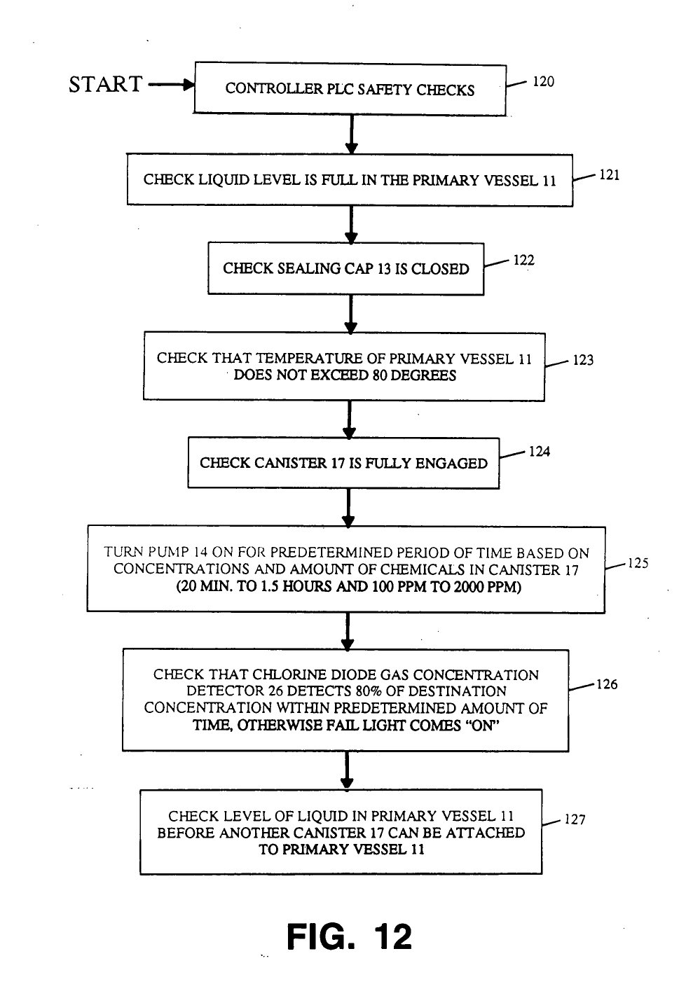

Referring to FIG. 12, the controller 27 performs a plurality of safety checks 120 when the chlorine dioxide generator 10 is turned-ON. The first check 121 checks that the liquid level is full in the primary vessel 11 before starting the pump 14. The second check 122 checks that the sealing cap 13 is closed. The third check 123 checks that the temperature of the primary vessel 11 does not exceed 90 degrees Fahrenheit. The fourth check 124 checks that the canister 17 is fully engaged into the primary vessel 11. The fifth check 125 turns pump 14 ON for predetermined periods of time based on concentration and amount of chemicals in canister 17 (20 minutes to 1.5 hours and 100 PPM to 200 PPM). The sixth check 126 checks that chlorine dioxide gas concentration detector detects 80% of destination concentration with predetermined amount of time, otherwise FAULT light 134 is turned-ON. The seventh check 127 checks that the level of liquid in primary vessel 11 before allowing another canister 17 to be attached to the primary vessel 11.

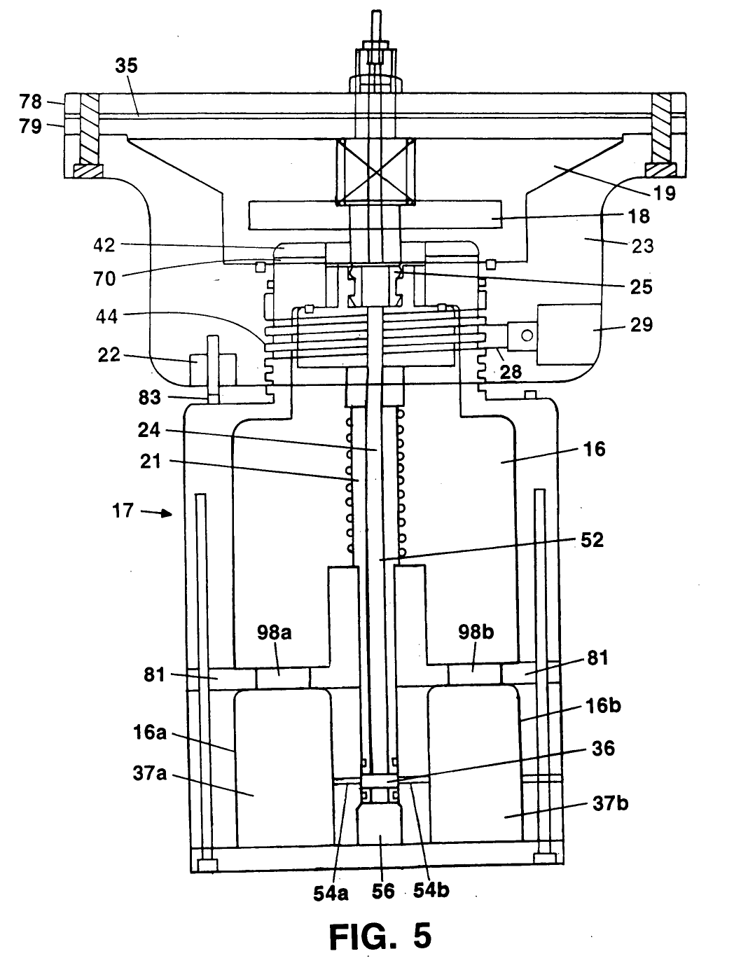

Referring now to FIG. 5 and FIG. 6, FIG. 5 is a cross-sectional view of a half-engaged canister 17 into the vessel receptacle 23 with a partially opened gas flow lid 18 in the vessel receptacle 23. The top portion of the neck 42 of the canister 17 includes radial grooves 70 through which the generated chlorine dioxide gas 50 flows into the gas flow chamber 19 when the canister 17 is fully engaged and then into a recipient solution chamber 20 of the primary vessel 11. In the half-engaged non-active position, the ridge 83 of the canister 17 has not yet activated the microswitch 22. The push-pull solenoid 29 is turned-on causing the solenoid rod 28 to be disengaged from a blind hole 53 in the threaded area 44 of canister neck 42 thereby allowing the canister to be screwed-in.

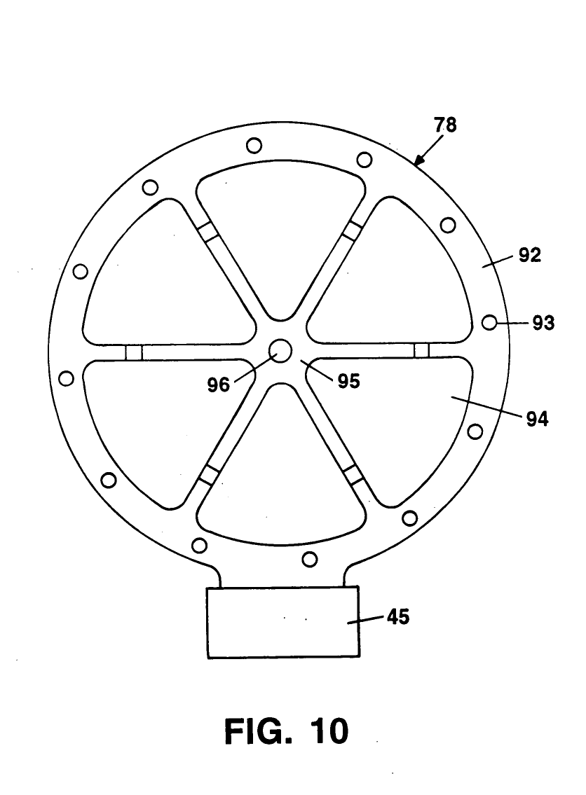

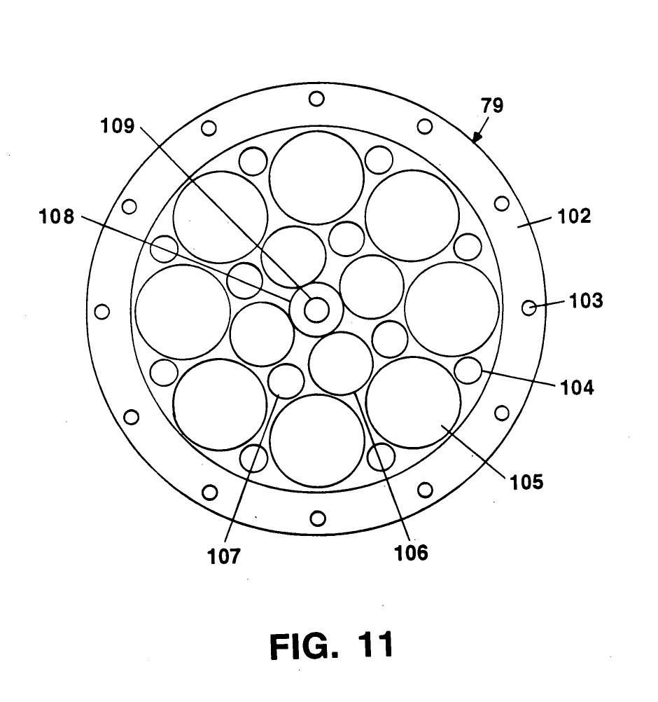

Referring to FIG. 4, FIG. 5, FIG. 10 and FIG. 11, FIG. 10 is a top plan view of a top gas valve plate 78 of the vessel receptacle 23, and FIG. 11 is a top plan view of a bottom gas valve plate 79. In between the plates 78 and 79 is a gas valve membrane 35 which allows the chlorine dioxide gas 50 generated in the canister 17 to pass into the solution chamber 20 of the primary vessel 11, but does not allow the solution in the solution chamber 25 to pass through the gas valve membrane 35 into the gas flow chamber 19. The top gas valve plate 78 comprises a circular plate comprising a bolt circle area 92 on the outermost surface of the top gas valve plate 78 having twelve 0.218 diameter holes 93 evenly spaced for receiving bolts to secure the top and bottom gas valve plates 78, 79 together with the gas membrane 35 between the plates 78, 79. The top plate 78 primarily comprises six triangular shaped openings 94, each opening having an arc of slightly less than 60 degrees extending from a center area 95 of the top plate 78 having a center hole 96 with a 0.375 inch diameter. The gas valve membrane 35 may be embodied by a 0.1μ GORE-TEX® membrane on polyester, SKU:SMP4, manufactured by WL Gore Associates, Inc. of Elkton, Md.

Referring to FIG. 11, the bottom gas valve plate 79 comprises a plurality of different diameter holes within the plate 79 providing many spaces for chlorine dioxide gas 50 to pass through and at the same time stable support the gas valve membrane 35 disposed between the top gas valve plate 78 and the bottom gas valve plate 79. A bolt circle area 102 on the outermost surface of the bottom gas valve plate 79 comprises twelve 0.22 inch diameter holes 103 evenly spaced for receiving the securing bolts. Next there are eight 0.44 inch diameter holes 104 evenly spaced on a 5.22 inch diameter bolt circle. In between the 0.44 inch diameter holes are eight 1.50 inch diameter holes 105 evenly spaced on a 4.29 inch diameter bolt circle. Adjacent to the 1.50 inch diameter holes are four 1.06 inch diameter holes 106 evenly spaced on a 1.86 inch diameter bolt circle. Four additional 0.59 inch diameter holes 107 are evenly spaced between the 1.5 inch diameter holes 105 and the 1.06 diameter holes 106 on a 2.49 diameter bolt circle. A center area 108 of the bottom gas valve plate 79 comprises a 0.375 inch center hole 109. The above dimensions are approximate and may vary depending on the diameter of the vessel receptacle 23.

### Generator Operation

Referring again to FIG. 4, to operate the chlorine dioxide generator 10, the main power switch 130 on the control panel 60 is switched ON and the primary vessel 11 along with the priming chamber 12 are filled with water via the top inlet which is covered by double sealing cap 13 thereby closing both chambers to atmosphere. When the canister 17 is becoming engaged into the vessel receptacle 23, an operator must press a canister engage button 132 on the control panel 66 which enables the operator to freely engage the canister 17 within a given period of time. If the operator does not engage the canister 17 fully within the predetermined period of time, this step has to be repeated.

Once the canister 17 is fully engaged, a RUN indicator light 133 on the control panel 60 comes ON indicating the canister 17 is fully engaged. At this point, power is turned off from the solenoid 29 and the solenoid rod 28 enters a canister lock slot 53. At this point an operator cannot remove the canister 17 until a reaction goes to completion or an expert operator removes the canister 17.

The controller 27 is under program control stored in a memory within the PLC of the controller 27. The controller 27 checks several sensors as shown in FIG. 10 such as a full fluid level 121, a secure double sealing cap 122 and temperature 123, and displays the status information on a fault indicator 134 on the control panel 60, if there is a failure. If all test conditions are satisfied, the controller 27, which is connected to the control panel 60, has a time delay of several seconds after which the controller 27 turns on the air pump 14.

Then, the priming chamber 12 is pressurized and the water in the priming chamber 12 is forced through the air-primer feed line 15 to the canister reaction chamber 16. The canister 17 then fills with the predetermined amount of water from the priming vessel 12 followed by a continuous flow of air for approximately 25-30 minutes, which flows through the now dry priming vessel 12 and to the canister reaction chamber 16. The gas 60 bubbles flow out of canister 17, through the recipient solution and accumulate in the upper portion of vessel 11 and in the dome 28. There is a port 31 on the top of the dome 38 which is connected to the vacuum side of the pump 14. This make-up air has CLO₂ gas in air which is recirculated through the generator 10 by the pump 14.

This closed loop operation optimizes gas transfer to the recipient solution.

The canister 17 of the chlorine dioxide generator 10 is a triple action, replaceable, screw-in reaction vessel. The triple action includes the following steps of reaction: a) the partial opening of a spring loaded gas flow lid 18 in the gas flow chamber 19 beneath the recipient solution chamber 20 in the primary vessel 11, b) the complete opening of the spring loaded canister gas flow valve 21, and c) the completion of opening of the spring loaded gas flow lid 18, which then triggers the sequence of pump-initiation-gas flow. This is achieved by activating the canister proximity microswitch 22, which closes the contacts to an electrical relay in the controller 27. This sequence starts the reaction sequence to generate the chlorine dioxide gas 50. The triple acting aspect is a safety feature incorporated to insure that the initiation of the reaction of dry chemicals 37a, 37b in the canister 17 does not occur until both the gas flow lid 18 is opened and the canister 17 is fully engaged and sealed into the vessel receptacle 13.

Still referring to FIG. 4, another safety and quality assurance element of the device is the incorporation of the optical, gas concentration detector 26. Alternately, the sensor could be an oxidation sensor or any other device capable of detecting change in solution concentration. The gas concentration detector 26 is calibrated to change states at a given spectral shift or optical density, which corresponds with the appropriate final concentration of the solution desired in the solution chamber 20. For example, if the desired final concentration (after the reaction in the canister 17 has gone to completion) of the recipient solution is to be 1000 ppm, the gas concentration detector 26 will trigger when the recipient solution is slightly less than 1000 ppm, such as 900-950 ppm. If the total reaction time to completion is estimated to occur within 30 minutes, the air pump 14 is then instructed by the controller 27 to stay on for an additional 10-20% (4-5 minutes) to insure the reaction goes to completion before being turned-off. This allows for the tolerances in the gas concentration detector 26 and also insures that the reaction will go to completion. If the device looses electrical power, the airflow from the air pump 14 would be interrupted causing the reaction time to completion to be increased by possibly hours. The controller 27 in this case would then reset upon regaining power and instruct the generator 10 to repeat its complete operating routine again until completed. The gas concentration detector 26 may be embodied by Model CZK1 manufactured by Keyence Corp. of America of Woodcliff Lake, N.J.

The dry chemicals 37a, 37b in the canister, cannot be removed once the reaction is initiated until the chemical reaction goes to completion: This is because the canister 17 is self-sealing only upon removal. If the canister 17 was resealed immediately after initiation, the generated gas within the canister 17 could possibly build up too high of a pressure if all other safety devices failed. Since the chlorine dioxide gas 50 may be unstable at very high concentrations, its pressure could possibly burst the canister 17 and release the gas in a high concentration. Therefore, the generator 10 incorporates the locking solenoid 29, which locks the canister 17 just prior to initiation of the chemical reaction and will not release the canister 17 until the chemical reaction has gone to completion. This is achieved by the push-pull solenoid 29 that is normally engaged (without power), thereby inhibiting rotation of the screw-in canister 17 until the push-pull solenoid 29 is energized. The solenoid 29 may be embodied by Model 195202-234, manufactured by LEDEX Products of Vandalia, Ohio.

A vessel relief valve 30 (or optional redundant dual vessel relief valves in parallel) is also incorporated on the top vessel dome 38 of the primary vessel 11. The vessel relief valve 30 allows for the following: venting when power is lost, venting when the recipient solution is being emptied from the vessel 11, and venting if an elevated temperature is sensed by the controller 27 while under power. Elevated temperatures may result in unwanted elevated gas pressure in the air spaces within the vessel 11. This is important because the preferred situation is to have atmospheric pressure above the solution, thereby keeping the optimum amount of chlorine dioxide gas 50 in the solution. The vessel relief valve 30 may be embodied by Model 501200, manufactured by ADVANTEC MFS, INC., of Pleasanton, Calif.

A canister relief valve 32 is incorporated into the top of the canister 17 to prevent an overpressure situation as mentioned earlier. The canister relief valve 32 is designed to relieve pressure from within the canister 17. The size of the vent hole 32 is 1/16 inch in diameter with provisions for an O-ring and PTFE membrane material to cover it.

The chlorine dioxide generator 10 is approximately 40 inches in height. The primary vessel 11 is 9 inches in diameter×22 inches high, comprising type 304 stainless steal ⅛ inch thick. It holds approximately 22 liters or 5 gallons. The canister 17 is approximately 8 inches high and 4 inches in diameter. Two mounting bars 40a, 40b are welded on to the side of the primary vessel 11. The stainless steel is coated with PTFE to avoid oxidation. The housing of the canister 17 is made of CPVC plastic. The O-rings are all rubber and gaskets are made of fluorocarbon rubber. All tubing is PTFE or FEP. All fittings are PVDF plastic. Alternatively, all of the stainless steel components could be made of plastic. Among the preferred materials are PUDF, CPVC and PVC. The geometry of the components could also be sealed larger or smaller to generate more or less gas in solution.

This invention has been disclosed in terms of certain embodiment. It will be apparent that many modifications can be made to the disclosed apparatus without departing from the invention. Therefore, it is the intent of the appended claims to cover all such variations and modifications as come within the true spirit and scope of this invention.

What is claimed is:

1. A chlorine dioxide generator comprising:
a primary vessel having a solution chamber;
means for supplying priming water to a canister attached to said primary vessel;
said canister having predetermined chemicals for producing chlorine dioxide gas, said canister sealably engages to said primary vessel; and
means for providing a path for said priming water and air to pass through said primary vessel to said canister when said canister is engaged to said primary vessel.

2. The chlorine dioxide generator as recited in claim 1 wherein said generator comprises means for locking said canister within said primary vessel when said canister is fully engaged to said primary vessel.

3. The chlorine dioxide generator as recited in claim 1 wherein said primary vessel comprises a receptacle for directly engaging with said canister.

4. The chlorine dioxide generator as recited in claim 3 wherein said receptacle comprises a gas flow lid having a feed tube inserted in said lid, said lid being opened when said canister is fully engaged with said receptacle.

5. The chlorine dioxide generator as recited in claim 4 wherein said canister comprises a grommet in the engaging end of said canister for sealably engaging with said feed tube of said gas flow lid.

6. The chlorine dioxide generator as recited in claim 3 wherein said vessel receptacle comprises a membrane for allowing a gas generated in said canister to pass into said solution chamber of said primary vessel.

7. The chlorine dioxide generator as recited in claim 1 wherein said primary vessel comprises means for sensing when said canister is fully engaged to said primary vessel prior to start of a chemical reaction sequence.

8. The chlorine dioxide generator as recited in claim 1 wherein said canister comprises a relief valve to prevent an overpressure of said generated chlorine dioxide gas from occurring in said canister.

9. The chlorine dioxide generator as recited in claim 1 wherein said primary vessel comprises means for detecting a predetermined gas concentration in said solution chamber.

10. The chlorine dioxide generator as recited in claim 1 wherein a pump provides said air to said primary vessel.

11. The chlorine dioxide generator as recited in claim 10 wherein a controller is connected to said pump, said controller having a control panel for controlling and monitoring the operation of said chlorine dioxide generator.

12. The chlorine dioxide generator as recited in claim 1 wherein said canister comprises at least two chambers for storing said predetermined chemicals.

13. A chlorine dioxide generator comprising:
a primary vessel having a priming chamber and a solution chamber;
said primary vessel comprises a first inlet for receiving air for delivery to said priming chamber and a second inlet for receiving water for delivery to said priming chamber and said solution chamber;
a canister having predetermined chemicals for producing chlorine dioxide gas, said canister sealably engages to said primary vessel; and
means for providing a path for said water and said air to pass from said priming chamber to said canister when said canister is engaged to said primary vessel.

14. The chlorine dioxide generator as recited in claim 13 wherein said generator comprises means for locking said canister within said primary vessel when said canister is fully engaged to said primary vessel.

15. The chlorine dioxide generator as recited in claim 13 wherein said chemicals react with said water provided to said canister from said priming chamber to produce said chlorine dioxide gas.

16. The chlorine dioxide generator as recited in claim 13 wherein said primary vessel comprises a receptacle for directly engaging with said canister.

17. The chlorine dioxide generator as recited in claim 16 wherein said receptacle comprises a gas flow lid having a feed tube inserted in said lid, said lid being opened when said canister is fully engaged with said receptacle.

18. The chlorine dioxide generator as recited in claim 17 wherein said canister comprises a grommet in the engaging end of said canister for sealably engaging with said feed tube of said gas flow lid.

19. The chlorine dioxide generator as recited in claim 16 wherein said vessel receptacle comprises a membrane for allowing a gas generated in said canister to pass into said solution chamber of said primary vessel.

20. The chlorine dioxide generator as recited in claim 13 wherein said primary vessel comprises means for sensing when said canister is fully engaged prior to start of a chemical reaction sequence.

21. The chlorine dioxide generator as recited in claim 13 wherein said canister comprises a relief valve to prevent an overpressure of said generated chlorine dioxide gas from occurring in said canister.

22. The chlorine dioxide generator as recited in claim 13 wherein said primary vessel comprises means for detecting a predetermined gas concentration in said solution chamber.

23. The chlorine dioxide generator as recited in claim 13 wherein a pump provides said air to said primary vessel.

24. The chlorine dioxide generator as recited in claim 23 wherein a controller is connected to said pump, said controller having a control panel for controlling and monitoring the operation of said chlorine dioxide generator.

25. A primary vessel for a chlorine dioxide generator comprising:
a solution chamber;
a vessel plate attached to the top of said solution chamber;
a vessel receptacle attached to a bottom of said solution chamber having a gas membrane located at the interface between said vessel receptacle and said solution chamber;
means for providing a path for priming water to flow through said vessel receptacle; and
said vessel receptacle comprises means for receiving a source of chlorine dioxide gas.

26. The primary vessel as recited in claim 25 wherein said top vessel plate comprises an anti-siphon block having an input from said priming chamber and an output connected to said valve on said vessel receptacle.

27. The primary vessel as recited in claim 25 wherein said gas membrane located at the interface between said vessel receptacle and said solution chamber allows for the passage of chlorine dioxide gas into said solution chamber.

28. The primary vessel as recited in claim 25 wherein said primary vessel comprises a gas concentration detector positioned within said solution chamber.

29. The primary vessel as recited in claim 25 wherein said vessel receptacle comprises a gas flow lid which opens when said chlorine dioxide gas source is attached to said vessel receptacle.

30. The primary vessel as recited in claim 25 wherein said chlorine dioxide gas source comprises a canister having predetermined chemicals for producing chlorine dioxide gas.

31. A primary vessel for a chlorine dioxide generator comprising:
a solution chamber;
a vessel plate attached to the top of said solution chamber;
a priming chamber located within an upper portion of said solution chamber having an opening extending through said vessel plate;
a vessel receptacle attached to a bottom of said solution chamber having a gas membrane located at the interface between said vessel receptacle and said solution chamber;
said vessel receptacle comprises means for receiving a source of chlorine dioxide gas; and
means for providing a path for liquid to flow from said priming chamber to a valve in said vessel receptacle.

32. The primary vessel as recited in claim 31 wherein said vessel plate comprises a dome having a valve for receiving a first air supply tube, and a second air supply tube connects to said priming chamber for supplying air.

33. The primary vessel as recited in claim 31 wherein said top vessel plate comprises an anti-siphon block having an input from said priming chamber and an output connected to said valve on said vessel receptacle.

34. The primary vessel as recited in claim 31 wherein said gas membrane located at the interface between said vessel receptacle and said solution chamber allows for the passage of chlorine dioxide gas into said solution chamber.

35. The primary vessel as recited in claim 31 wherein said primary vessel comprises a gas concentration detector positioned within said solution chamber.

36. The primary vessel as recited in claim 31 wherein said vessel receptacle comprises a gas flow lid which opens when said chlorine dioxide gas source is attached to said vessel receptacle.

37. The primary vessel as recited in claim 31 wherein said chlorine dioxide gas source comprises a canister having predetermined chemicals for producing chlorine dioxide gas.

38. A method of generating a chlorine dioxide solution comprising the steps of:
providing a primary vessel having a solution chamber and a canister attached to said solution chamber;
providing water to said solution chamber;
providing predetermined chemicals in said canister for producing chlorine dioxide gas for delivery to said primary vessel; and
providing a path through said primary vessel for priming water and air to pass to said canister for generating said chlorine dioxide gas.

39. The method as recited in claim 38 wherein said method comprises the step of providing means for locking said canister within said primary vessel when said canister is fully engaged to said primary vessel.

40. The method as recited in claim 38 wherein said step of providing a path for said priming water and said air to pass to said canister comprises the step of said predetermined chemicals reacting with said priming water provided to said canister to produce said chlorine dioxide gas.

41. The method as recited in claim 38 wherein said step of providing said primary vessel comprises the step of providing a receptacle having a gas flow lid with a feed tube inserted in said lid, said lid being opened when said canister is fully engaged with said receptacle.

42. The method as recited in claim 41 wherein said step of providing a receptacle comprises the step of providing a membrane for allowing a gas generated in said canister to pass into said solution chamber of said primary vessel.

43. The method as recited in claim 38 wherein said step of providing a primary vessel comprises the step of sensing when said canister is fully engaged prior to start of a chemical reaction sequence.

44. The method as recited in claim 38 wherein said step of connecting a canister comprises the-step of providing a relief valve to prevent an overpressure of said generated chlorine dioxide gas from occurring in said canister.

45. The method as recited in claim 38 wherein said step of providing a primary vessel comprises the step of detecting a predetermined gas concentration in said solution chamber.

46. The method as recited in claim 38 wherein said method comprises the step of providing a pump to supply said air to said primary vessel.

47. The method as recited in claim 38 wherein said method comprises the step of providing a controller having a control panel for controlling and monitoring the operation of generating said chlorine dioxide solution.

48. A method of generating a chlorine dioxide solution comprising the steps of:
providing a primary vessel having a priming chamber and a solution chamber;
providing a first inlet in said primary vessel for receiving air for delivery to said priming chamber;
providing a second inlet in said primary vessel for receiving water for delivery to said priming chamber and said solution chamber;
connecting a canister having predetermined chemicals for producing chlorine dioxide gas to said primary vessel; and
providing a path for said water and said air to pass from said priming chamber to said canister when said canister is engaged to said primary vessel for generating said chlorine dioxide gas.

49. The method as recited in claim 48 wherein said step of connecting a canister to said primary vessel comprises the step of providing means for locking said canister within said primary vessel when said canister is fully engaged to said primary vessel.

50. The method as recited in claim 48 wherein said step of providing a path for said water and said air to pass to said canister causes said chemicals to react with said water provided to said canister from said priming chamber to produce said chlorine dioxide gas.

51. The method as recited in claim 48 wherein said step of providing said primary vessel comprises the step of providing a receptacle having a gas flow lid with a feed tube inserted in said lid, said lid being opened when said canister is fully engaged with said receptacle.

52. The method as recited in claim 51 wherein said step of providing a receptacle comprises the step of providing a membrane for allowing a gas generated in said canister to pass into said solution chamber of said primary vessel.

53. The method as recited in claim 48 wherein said step of providing a primary vessel comprises the step of sensing when said canister is fully engaged prior to start of a chemical reaction sequence.

54. The method as recited in claim 48 wherein said step of connecting a canister comprises the step of providing a relief valve to prevent an overpressure of said generated chlorine dioxide gas from occurring in said canister.

55. The method as recited in claim 48 wherein said step of providing a primary vessel comprises the step of detecting a predetermined gas concentration in said solution chamber.

56. The method as recited in claim 48 wherein said method comprises the step of providing a pump to supply said air to said primary vessel.

57. The method as recited in claim 47 wherein said method comprises the step of providing a controller having a control panel for controlling and monitoring the operation of generating said chlorine dioxide solution.

58. A canister for generating chlorine dioxide gas comprising:
means for attaching said canister to a device for receiving said chlorine dioxide gas;
means for storing chemicals within said canister to generate said chlorine dioxide gas;
means for providing a path within said canister for air and water to come in contact with said chemicals to generate said chlorine dioxide gas.

59. The canister as recited in claim 58 wherein said attaching means comprises a threaded neck portion for screwing said canister into said device.

60. The canister as recited in claim 58 wherein said attaching means comprises a tube having a first end attached to said canister and a second end attached to said device for receiving said chlorine dioxide gas.

61. The canister as recited in claim 58 wherein said storing means comprises at least two chambers including a first chamber in a base portion of said canister for holding a first chemical and at least a second chamber in said base portion for holding a second chemical.

62. The canister as recited in claim 61 wherein said at least two chambers comprises holes between said first chamber and said at least second chamber, each of said holes being sealed by a water dissolvable film.

63. The canister as recited in claim 58 wherein said means for providing a path for air and water comprises a gas flow valve extending from a top portion of said canister to said chemical storing means.

64. The canister as recited in claim 63 wherein said gas flow valve comprises a grommet positioned on top of said valve for providing a seal when said canister is attached to said device for receiving said chlorine dioxide gas.

65. The canister as recited in claim 63 wherein said gas flow valve comprises a spring for sealing said valve when said canister is not connected to said device to prevent leakage of any chlorine dioxide gas.

66. The canister as recited in claim 58 wherein said canister comprises a relief valve to relieve an excess amount of pressure from within said canister.

67. The canister as recited in claim 58 wherein said canister comprises means for activating an engagement signal when said canister is completely attached to said device for receiving said chlorine dioxide gas.

68. A canister comprising:
a neck portion having a top surface with a plurality of slots for a generated gas to exit;
a base portion positioned under said neck portion having a larger area than said neck portion;
a gas flow valve positioned in the center of said canister extending through said neck portion and said base portion;
a first chamber in said base portion of said canister for holding a first chemical; and
a second chamber in said base portion of said canister adjacent to said first chamber for holding a second chemical.

69. The canister as recited in claim 68 wherein said neck comprises a threaded lower portion for screwing into a receiving receptacle.

70. The canister as recited in claim 68 wherein said gas flow valve comprises a grommet positioned on top of said valve for providing a seal with a mating receptacle.

71. The canister as recited in claim 68 wherein said gas flow valve comprises a tube extending from a grommet on top of said gas flow valve down to a valve which opens to ports for access to said first chamber and said second chamber.

72. The canister as recited in claim 68 wherein said base portion comprises a relief valve to relieve a predetermined amount of pressure from within said canister.

73. The canister as recited in claim 68 wherein said base portion of said canister comprises a ridge on an upper surface of said base portion for activating an engagement safety switch.

74. The canister as recited in claim 68 wherein said gas flow valve comprises a spring for sealing said valve when said canister is not connected to a gas receiving vessel.

75. The canister as recited in claim 68 wherein said first chamber and said second chamber in said base portions comprises at least one hole between said first chamber and said second chamber, said at least one hole being sealed by a water dissolvable film.

76. A method of generating chlorine dioxide gas in a canister comprising the steps of:
attaching said canister to a device for receiving said chlorine dioxide gas;
storing chemicals within said canister to generate said chlorine dioxide gas;
providing a path within said canister for air and water to come in contact with said chemicals to generate said chlorine dioxide gas.

77. The method as recited in claim 76 wherein said step of attaching said canister to a device for receiving said chlorine dioxide gas comprises the step of providing a threaded neck portion for screwing said canister into said device.

78. The method as recited in claim 76 wherein said step of attaching said canister to a device comprises the step of providing a tube having a first end attached to said canister and a second end attached to said device for receiving said chlorine dioxide gas.

79. The method as recited in claim 76 wherein said step of storing chemicals within said canister comprises the steps of providing a first chamber in a base portion of said canister for holding a first chemical, and providing a second chamber in said base portion for holding a second chemical.

80. The method as recited in claim 79 wherein said step of providing a first chamber and a second chamber in said base portion of said canister for storing chemicals comprises the steps of providing at least one hole between said first chamber and said second chamber and covering said at least one hole with a water dissolvable film.

81. The method as recited in claim 76 wherein said step of providing a path for air and water to contact said chemicals comprises the step of providing a gas flow valve extending from an upper portion of said canister to said stored chemical.
